(19) United States
(12) Patent Application Publication
(10) Pub. No.: US 2011/0208685 A1
(43) Pub. Date: Aug. 25, 2011

(54) Motion Capture Using Intelligent Part Identification

(76) Inventors: Hariraam Varun Ganapathi, Palo Alto, CA (US); Christian Plagemann, Menlo Park, CA (US); Sebastian Thrun, Stanford, CA (US); Daphne Koller, Stanford, CA (US)

(21) Appl. No.: 12/712,871

(22) Filed: Feb. 25, 2010

(51) Int. Cl. G06N 7/02

(52) U.S. Cl. 706/52

(57) ABSTRACT

Methods, systems, devices and arrangements are implemented for motion tracking. One such system for tracking at least one object articulated in three-dimensional space is implemented using data obtained from a depth sensor. The system includes at least one processing circuit configured and arranged to determine location probabilities for a plurality of object parts by identifying, from image data obtained from the depth sensor, features of the object parts. The processing circuit selects a set of poses for the at least one object based upon the determined location probabilities and generates modeled depth sensor data by applying the selected set of poses to a model of the at least one object. The processing circuit selects a pose for the at least one object model-based based upon a probabilistic comparison between the data obtained from the depth sensor and the modeled depth sensor data.

### FIELD

The present disclosure relates to the field of motion capture and to algorithms that facilitate the motion capture of a subject, such as by tracking and recording humans, animals and other objects in motion and in many cases without the use of added markers and/or in real time.

### BACKGROUND

Three-dimensional modeling of structures by a computer can be useful for a wide range of applications. Common applications relate to the generation of virtual structures to produce a visual display that depicts the structure. For example, video games often generate in-game characters using virtual models that recreate the motions of real-world actors, athletes, animals or other structures. Similar efforts are often undertaken for computer-generated characters in movies, television shows and other visual displays. The useful applications span areas as diverse as medicine, activity recognition, and entertainment. As robots become more commonplace in settings that include humans, they will need the ability to recognize human physical action.

Increasingly, the virtual modeling is moving away from the creation of a cartoon style appearance to more of a photo-realistic display of the virtual sets and actors. It can still take a tremendous effort to create authentic virtual doubles of real-world actors. Creation of a model that captures the muscle, joint, neurological and other intricacies of the human body is a prohibitively difficult proposition due to the sheer number of factors involved. Thus, modeling of a person is often implemented using motion capture of a real-world person. While in recent years, algorithms have been proposed that capture full skeletal motion at near real-time frame rates, they mostly rely on multi-view camera systems and specially controlled recording conditions which limits their applicability. It remains one of the biggest challenges to capture human performances, i.e., motion and possibly dynamic geometry of actors in the real world in order to map them onto virtual doubles.

### SUMMARY

Aspects of the present invention are directed to overcoming the above-mentioned challenges and others related to the types of applications discussed above and in other applications. These and other aspects of the present invention are exemplified in a number of illustrated implementations and applications, some of which are shown in the figures and characterized in the claims section that follows.

Consistent with one embodiment of the present disclosure, a system for tracking at least one object articulated in three-dimensional space is implemented using data obtained from a depth sensor. The system includes at least one processing circuit configured and arranged to determine location probabilities for a plurality of object parts by identifying, from image data obtained from the depth sensor, features of the object parts. The processing circuit selects a set of poses for the at least one object based upon the determined location probabilities and generates modeled depth sensor data by applying the selected set of poses to a model of the at least one object. The processing circuit selects a pose for the at least one object model-based based upon a probabilistic comparison between the data obtained from the depth sensor and the modeled depth sensor data.

Consistent with another embodiment of the present disclosure, a circuit-implemented method is provided for tracking at least one object articulated in three-dimensional space using data obtained from a depth sensor. The method includes determining location probabilities for a plurality of object parts by identifying, from image data obtained from the depth sensor, features of the object parts and selecting a set of poses for the at least one object based upon the determined location probabilities. Modeled depth sensor data is generated by applying the selected set of poses to a model of the at least one object. A pose is selected for the at least one object model-based based upon a probabilistic comparison between the data obtained from the depth sensor and the modeled depth sensor data.

The above summary is not intended to describe each illustrated embodiment or every implementation of the present invention.

### BRIEF DESCRIPTION OF THE DRAWINGS

The invention may be more completely understood in consideration of the detailed description of various embodiments of the invention that follows in connection with the accompanying drawings as follows:

FIG. 1A depicts an image sensor and processor arrangement, consistent with an embodiment of the present disclosure;

FIG. 1B depicts a flow diagram for motion capture from depth-based image data, consistent with an embodiment of the present disclosure;

FIG. 2 depicts modeling of a system as a dynamic Bayesian network, consistent with an embodiment of the present disclosure;

FIG. 3 depicts a sensor model for individual range measurements that approximates the mixture of a Gaussian (measurement noise) and a uniform distribution (outliers and mis-associations), consistent with an embodiment of the present disclosure;

FIG. 4 depicts a probabilistic model, consisting of the variables Vₜ, Xₜ, Vₜ₋₁, Xₜ₋₁ and \tilde{P}ⱼ, consistent with an embodiment of the present disclosure;

FIG. 5 depicts a flow diagram for generating a probable pose for a model, consistent with aspects of the present disclosure; and

FIG. 6 depicts results obtained from experimental implementations of a tracking algorithm, consistent with aspects of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure are believed to be useful for capturing and reconstructing movement of structures such as video-based performances of real-life subjects, whether human, animal, man-made or otherwise. Specific applications of the present disclosure facilitate markerless motion capture of subjects in an efficient and/or automated fashion. While the present disclosure is not necessarily limited to such applications, various aspects of the invention may be appreciated through a discussion of various examples using this context.

According to an embodiment of the present disclosure, motion capture is implemented to track the motion of one or more objects. The motion capture is implemented on a processing circuit that is configured to identify (probabilistic) locations of selected parts of the one or more objects from image data. The identified part locations are used in connection with a probabilistic model of the one or more objects. The probabilistic model helps determine the location and orientation of the objects with respect to the identified locations of the selected parts.

Many of the implementations discussed herein are particularly well-suited for use with a monocular sensor (e.g., a time-of-flight (TOF) sensor) that provides depth-based image data. The depth-based image data includes depth information for pixels of the image. The implementations and embodiments are not limited to only such applications and can be used in combination with a variety of data-types and sensors. For instance, aspects of the present disclosure may be particularly useful for supplementing or being supplemented by, traditional image capture devices based upon visible light intensities and/or colors.

In a particular implementation, the probabilistic model is based upon a correlation between a previous orientation or pose of the object and the new pose. For instance, the probability of a pose being correct decreases as the pose deviates significantly from the original pose. Particular probability constraints can be included to account for relative accelerations of different parts of the object. For instance, an assumption could be that object parts having a large mass are less likely to have rapid accelerations. For many situations, this assumption is reasonable, such as where the high levels of force necessary to accelerate large objects, are less likely to be present. This can be accomplished by modeling the probability of a pose using a covariance matrix set to be consistent with the mass of object parts. Other assumptions are also possible for modeling of the probability of particular poses. For instance, certain objects may be designated as more or less likely to have large accelerations based upon attributes other than mass alone.

In certain applications, an object, such as a human, can be modeled based upon skeletal joints and associated allowable movements of interconnected parts. A three-dimensional (deformable) surface mesh can then be placed on top of the underlying skeletal model.

Embodiments of the present disclosure relate to assessing a variety of poses by generating a simulation of sensor data from the poses. The simulated sensor data can then be compared against actual sensor data to assess the poses.

Various aspects can be particularly useful for improving the efficiency of the overall motion capture operation. One such aspect relates to using object part detections to determine a likely orientation/pose for the model of the object. Detected parts are associated with model components. In particular implementations, the parts are categorized into different part types (e.g., hands, feet or head). This can results in several possible hypotheses for orientations. These hypotheses can be evaluated by assessing their respective probabilities against actual sensor data.

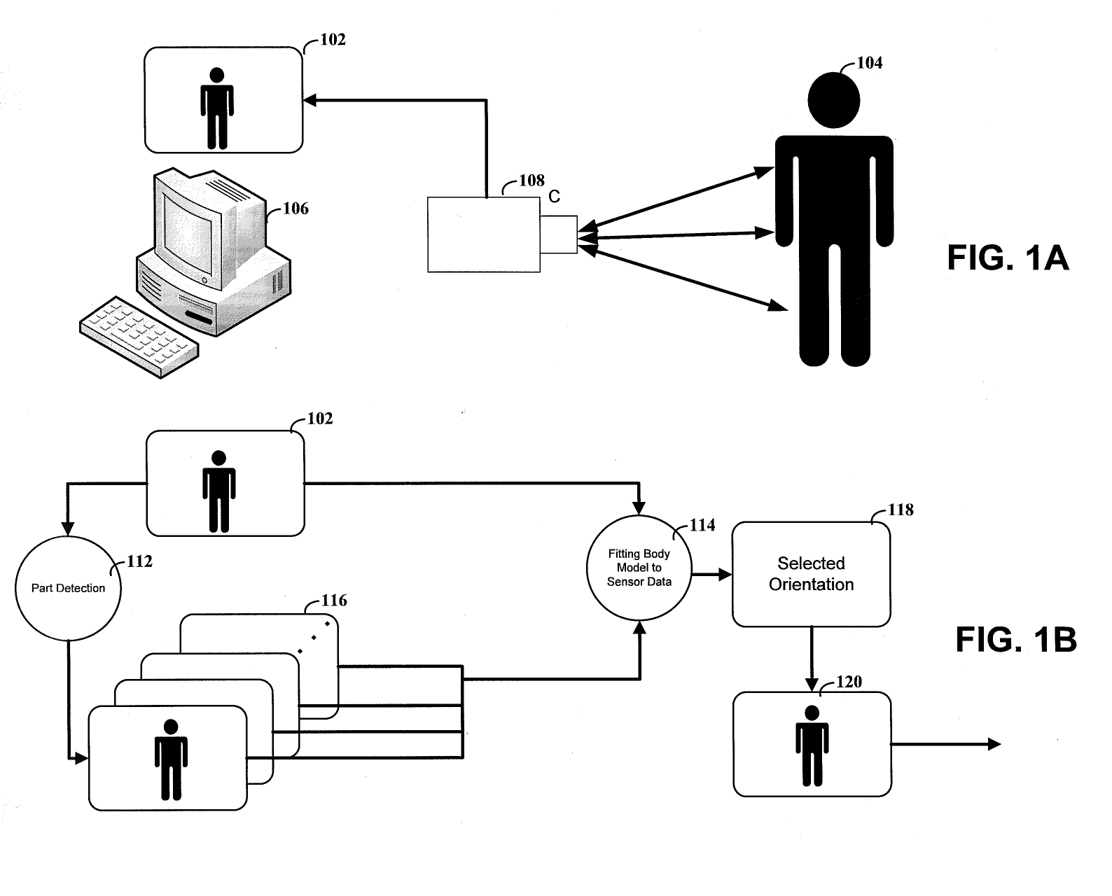

Turning now to the figures, FIG. 1A depicts an image sensor and processor arrangement, consistent with an embodiment of the present disclosure. Image sensor 108 captures image data 102, which includes structure 104. The flexibility of various embodiments of the present disclosure facilitates the use of a wide variety of sensors for image sensor 108. In a particular implementation, image sensor 108 is implemented using a time-of-flight sensor arrangement that provides depth measurements for structure 104 and other objects in the field of view.

Structure 104 is shown as a human; however, embodiments of the present disclosure are not so limited. For instance, various embodiments of the present disclosure are particularly well-suited for motion capture of structures for which skeletal modeling is appropriate. Other embodiments are also possible, particularly structures that can be modeled by a reasonable number of candidate poses defined by a set of movement constraints for various portions of the structure.

In specific implementations, image data 102 includes data that can be used to determine depth of objects within the field of view of image sensor 108. This data is provided to a processing device 106. Processing device 106 is depicted as a computer system; however, various processing circuits can be used. Moreover, combinations of multiple computers, hardware logic and software can be used. In a particular implementation, processing device 106 includes a parallel processor, such as a graphics processing unit (GPU). Processing device 106 uses the image data to generate a digital representation of the structure 104 as shown in more detail in FIG. 1B.

FIG. 1B depicts a flow diagram for motion capture from depth-based image data, consistent with an embodiment of the present disclosure. In general, FIG. 1B relates to the combination of two search strategies to fit a full-body model of a human to an acquired depth image. One search involves the use of a learned body-part detector 112, which directly predicts body part locations from features extracted from a depth image. Another search involves a model-based search 114, which uses a mesh-based model of the human body and searches for the best-fitting joint angles. The model-based search is particularly useful for providing a high tracking accuracy. The body-part detector 112 is particularly useful for providing robustness to the tracking algorithm (e.g., to re-initialize the tracker when it has lost track or to deal with overly large state transitions).

Aspects of the present disclosure relate to specifics for combining the two search approaches. One such approach is identified as Evidence Propagation (EP). EP fuses the prior distribution over body configurations (a high-dimensional Gaussian) with the predictive distributions of the body part detectors. The body-part detector 112 is used to generate a set of mesh-based models of the human body 116. These mesh-based models can thereby initialize the model-base search 114. The result is a selected orientation/pose 118 for the model. A final image 120 can then be generated and used accordingly (e.g., for video display or robotic tracking).

Examples of how the body-part detector learns how to identify parts include learning offline in a separate training phase and learning online on a per-frame basis. Further details on such learning are discussed herein.

A particular implementation of the present disclosure relates to an experimental method for tracking of a human body. While the present disclosure is not limited to tracking of the human body, the description thereof can be particularly helpful in understanding various concepts, which can then be applied to other objects and structures.

The method is designed to track an articulated body over time using a stream of monocular depth images. The method can be implemented using a variety of processing circuits, but has been shown to be particularly well-suited for parallel processing circuits, such as graphical processing units (GPUs). The processing circuit defines a probabilistic model for the variables of interest using a collection of fifteen rigid body parts, which are constrained in space according to a tree-shaped kinematic chain (skeleton). This kinematic chain is a directed acyclic graph (DAG) with well-defined parent-child relations. The surface geometry of the model is represented via a closed triangle mesh, which deforms with the underlying kinematic chain by means of a vertex skinning approach.

The configuration of the body is denoted by Xₜ={Xₜ¹, . . . , Xₜ^{N}} where each i indexes a uniquely defined body part in the chain. The transformations Xi can be represented in various ways, such as using homogeneous matrices or in vector/quaternion form. Independent from the choice of representation, Xi denotes the position and orientation of a specific body part relative to its parent part. The chain is “anchored” to the world at the pelvis Xₜ¹ (which does not does not have a parent in the kinematic tree). In the model, the pelvis is allowed to freely rotate and translate. The remaining body parts are connected to their parent via a ball joint, which allows them to rotate in any direction, but not to translate. The absolute orientation Wⁱ(X) of a body part i is obtained by multiplying the transformations of its ancestors in the kinematic chain, Wⁱ(X)=X¹ . . . X^{parent(i)} Xⁱ.

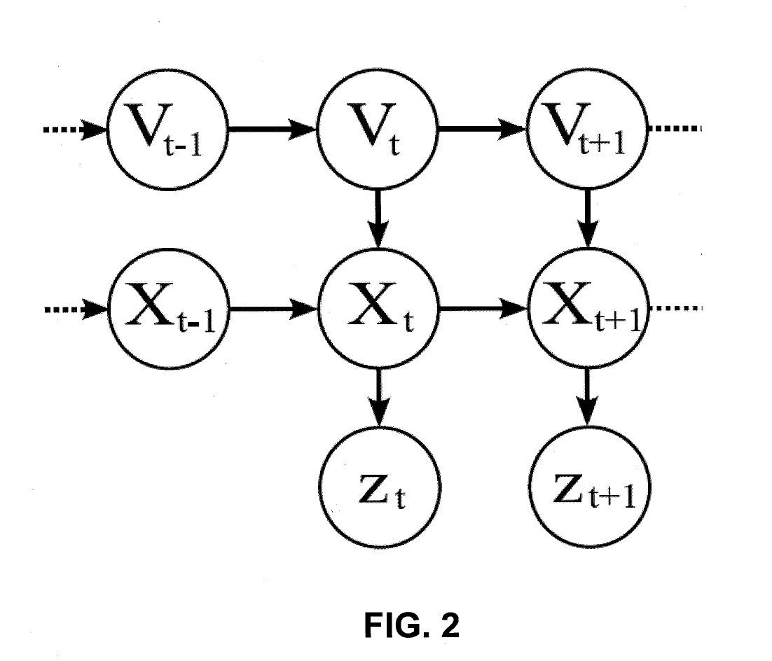

In order to determine the most likely state at any time, a probabilistic model is first defined. The state at time t is the pose Xₜ and its first discrete-time derivative Vₜ. The measurement is the range scan zₜ. The system can be modeled as a dynamic Bayesian network (see FIG. 2), which encodes the Markov independence assumption that Xₜ and Vₜ are independent of z₁, . . . , zₜ₋₁ given Xₜ₋₁ and Vₜ₋₁.

The Dynamic Bayesian Network (DBN) requires the specification of the conditional probabilities P(Vₜ|Vₜ₋₁), P(Xₜ|Xₜ₋₁, Vₜ) and the measurement model P(zₜ|Xₜ). It can be assumed that the accelerations in the system are drawn from a Gaussian distribution with zero mean, in which bigger body parts, due to the larger inertia, experience smaller accelerations than smaller body parts. Thus, P(Vₜ|Vₜ₋₁)=N(Vₜ₋₁, Σ) with the covariance matrix Σ being diagonal, with larger entries corresponding to the angular velocities of smaller limbs. Since X is a list of relative transformations, the velocities are also defined relatively. That is, if k is the index of the knee, V^{k}ₜ encodes the change in the angle between the shin and thigh at frame t. The covariance Σ can be specified by hand through bio-mechanical principles and the known video frame rate.

P(Xₜ|Vₜ, Xₜ₋₁) is defined to be a deterministic Conditional Probability Distribution (CPD) that applies the transformations in Vₜ to those in Xₜ₋₁. Formally, Xⁱₜ=VⁱₜXⁱₜ₋₁ with probability 1.

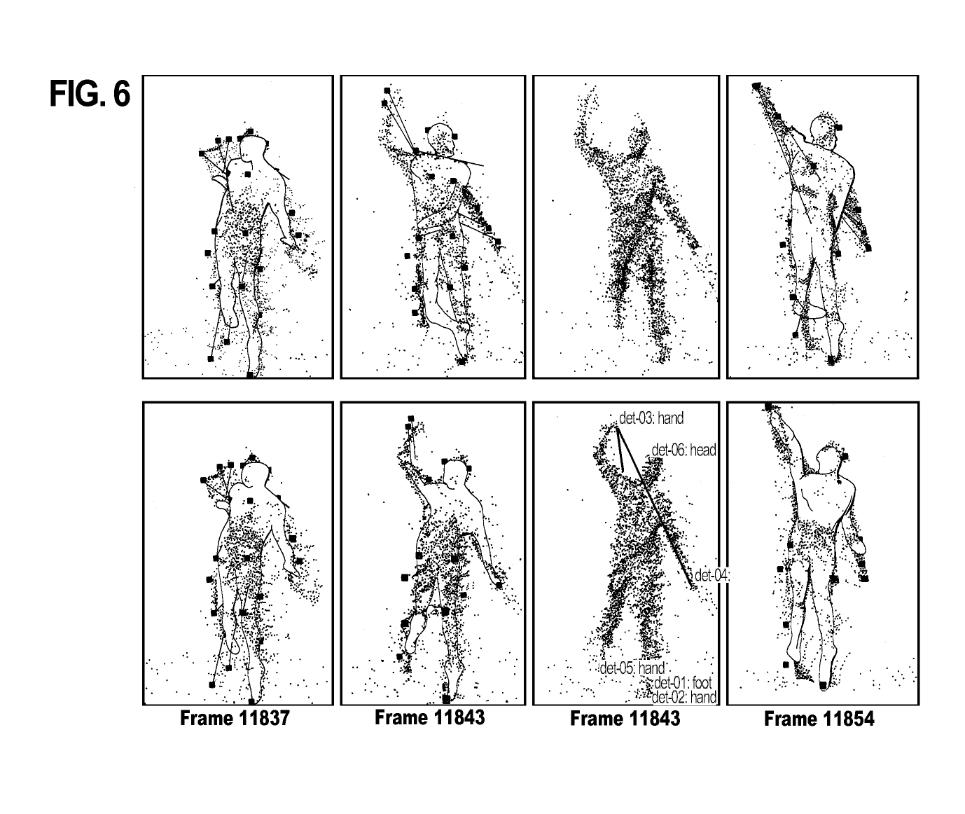

The measurement model defines the distribution on the measured range data given the state of the system. The measured range scan is denoted by z={z^{k}} where z^{k} gives the measured depth of the pixel at coordinate k. An example scan is shown in FIG. 6. It is assumed that the conditional independence of each pixel given the state and geometry m,

$$P ( {z}_{t} \vert {X}_{t} , m ) = {\prod }_{k} P ( {z}_{t}^{k} \vert {X}_{t} , m ) .$$

To generate the z^{k} for a specific body configuration X and model m, the vertices corresponding to each part i are transformed by their corresponding transformation matrix Wⁱ(X). A ray is then cast from the focal point through pixel k and the distance to the first surface it hits is calculated, which is denoted herein as z^{k}*.

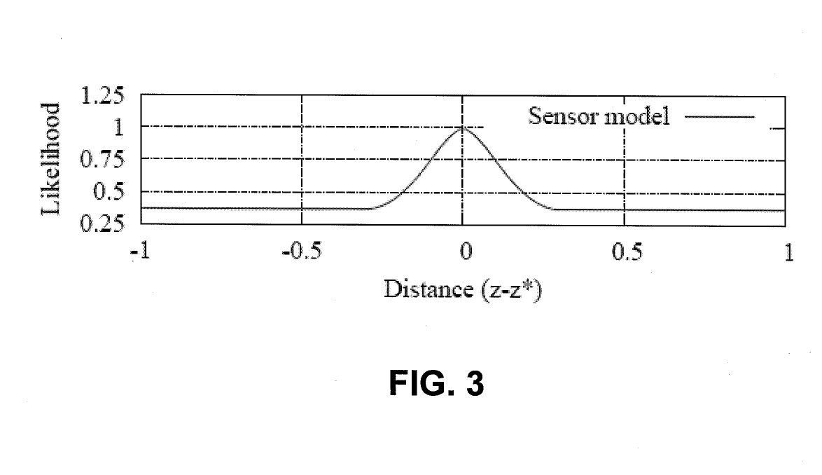

Given the ideal depth value, a noise model can then be applied for the given sensor. One approach is to explicitly model the different types of noise that can occur. In principle, one can enumerate the effects, such as Gaussian noise of the sensor, the probability of a max range reading, outliers, and others. A particular approach involves the use of a CPD that can use the function shown in FIG. 3, which depicts a sensor model for individual range measurements that approximates the mixture of a Gaussian (measurement noise) and a uniform distribution (outliers and mis-associations). Aspects relate to the definitions smoothstep(x)=(min(x, 1))² (3−2 min(x, 1)), and

p(|z^{k}−z^{k}*|)α exp(−smoothstep(|z^{k}−z^{k}*|))

This function was chosen for its approximation of a Gaussian mixed with a uniform distribution and for use with existing function in the GPU shading language.

The goal need not be to have the most accurate generative model, but rather to determine the most likely state at time t given the MAP assignment of the previous frame, which can be denoted as \hat{X}ₜ₋₁, \hat{V}ₜ−1. At each frame, there can be a difficult, high dimensional optimization problem

argmax_{X}_{ₜ}_{,V}_{ₜ} log P(zₜ|Xₜ,Vₜ)+log P(Xₜ,Vₜ|\hat{X}ₜ₋₁,\hat{V}ₜ₋₁)

Such a measurement model can be considered less than adequate due to its sensitivity to incorrect models m and to slight changes in the state X. Parts of the model that violate their silhouette in the measured image will be penalized heavily. For instance, slightly translating an object will result in all pixels at the edges evaluating an incorrect depth value, which would be penalized heavily. The above sensor model partially accounts for this problem by using a distribution that has a much heavier tail than a Gaussian, but it is still peaked since it is fundamentally restricted to pixel-wise correspondences and cannot model pixel mis-associations well.

It has frequently been observed that the true likelihood is often ill-suited for optimization, and surrogate likelihoods are often used. Aspects of the present disclosure relate to development of a function that is more robust to the mis-association that occurs during optimization. The likelihood can be rewritten as l(X) in terms of z(X), the depth image can be obtained through ray-casting applied to X. l(X)=Σₖ log P(z^{k}|z(X))=Σₖ log P(z^{k}|z^{k}(X). An alternate smoother can be constructed with the likelihood parameterized by a penalty function λ.

$${l}_{smooth} ( X ) = {\sum }_{k} {max}_{j} log P ( {z}^{k} \vert {z}^{j} ( X ) ) + λ ( j , k )$$

λ(j, k) represents a cost for choosing a different pixel index than the one predicted by ray casting. For instance, λ(j, k)=−∞, can be used if j is not an immediate pixel neighbor of k, λ(j, k)=0 if j=k and λ(j, k)=−0.05 in all other cases. −0.05 was chosen based on the following reasoning: Based on the field of view of the sensor, the subject will be approximately 2 meters away in order to fit completely. At that distance, moving to a neighboring pixel results in a Euclidean distance of approximately 0.05 meters perpendicular to the direction the camera is facing. Near the minimum, the log likelihood of the noise model is approximately quadratic. Thus, the total penalty function approximates Euclidean distance for close matches. Accordingly, X can be chosen to increase the neighborhood, albeit at increased computational expense, and possible degradation of accuracy.

Inference to the described the probabilistic state space and measurement model is non-trivial due to the high-dimensional nature of the space of the kinematic configuration space X and the associated velocity space V. This is particularly challenging for real time tracking or other implementations where an exhaustive inference may be infeasible.

Aspects of the present disclosure relate to performance of an efficient MAP inference at each frame. This problem can be tracked in two ways: (1) A model-based component locally optimizes the likelihood function by hill-climbing and (2) a data-driven part processes the measurement z to reinitialize parts of the filter state when possible. For the latter component, an approximate inference procedure, termed evidence propagation, is derived to generate likely states which are then used to initialize the model-based algorithm.

To locally optimize the likelihood, a coarse-to-fine hill-climbing procedure was implemented. The procedure can be initialized according to the base of kinematic chain which includes the largest body parts, after which the procedure can ascertain positions for the limbs. For a single dimension i of the state space, a grid of values is sampled about the mean of p(Vⁱₜ|Vⁱₜ₋₁). For each sample of Vₜ the state Xₜ is deterministically generated from \hat{X}ₜ₋₁. The likelihood of this state is evaluated, and the best one of the grid chosen. The procedure can then potentially be applied to a smaller interval about the value chosen at the coarser level. For example, to optimize the X axis of the pelvis, it is possible to sample values between −0.5 to 0.5 at intervals of 0.05 meters. The benefit of such a procedure is that it is well-suited for parallel processing. Thus, a batch of candidates can be sent to a GPU, which evaluates all of them and returns their costs.

A variety of effects can cause the model-based search to fail. One problem is that fast motion causes significant motion blur. Additionally, occlusion can cause the estimate of the state of hidden parts to drift. Additionally, the likelihood function has ridges that are difficult to navigate. A data-driven procedure can therefore be used to identify promising locations for body parts in order to find likely poses.

The three steps in this procedure are (I) to identify possible body part locations from the current range image, (II) to update the body configuration X given possible correspondences between mesh vertices and part detections, and (III) to determine the best subset of such correspondences.

An example implementation considers five body parts head, left hand, right hand, left foot and right foot. The three-dimensional world locations of these parts according to the current configuration X of the body are denoted as pᵢ, iε{1, . . . , 5}. These parts can be represented by single vertices on the surface mesh of the body, such that all pᵢ are deterministic functions of X. The data-driven detections of body parts are denoted as \tilde{p}ⱼ, jε{1, . . . J}, where Jε [symbol] can be an arbitrary number depending on the part detector. Actual body parts as well as the detections have a class assignment cᵢ, \tilde{c}ⱼ to {head; hand; foot}. The body part detections can be produced by a two step procedure. In the first step, external points on the recorded surface mesh are determined from the range measurement zₜ to form a set of distinct interest points. Discriminatively trained classifiers are applied to patches centered on the points to determine to what body part class they belong. If the classifier is sufficiently confident, the feature is reported as a positive detection.

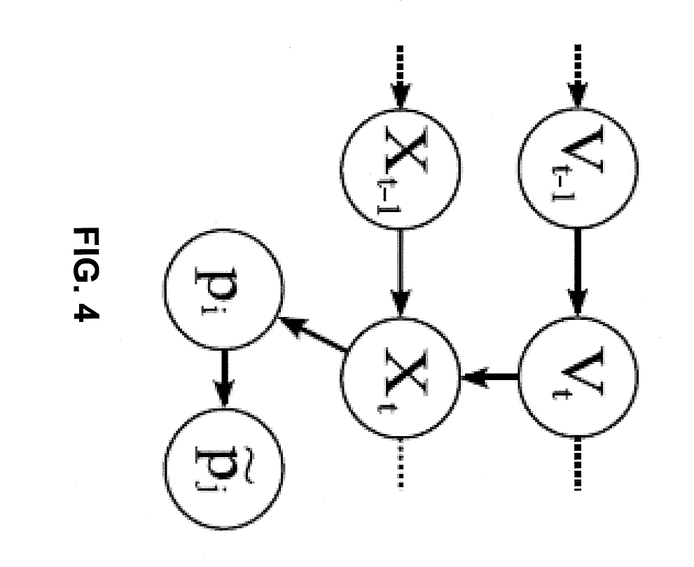

FIG. 4 depicts a probabilistic model, consisting of the variables Vₜ, Xₜ, Vₜ₋₁, Xₜ₋₁ and \tilde{p}ⱼ, consistent with an embodiment of the present disclosure. Assuming a correspondence between body part i and detection j, the following observation model is applied:

\tilde{p}ⱼ=pᵢ(X)+ [symbol] (0,Σₒ)

A MAP estimate is calculated of X and Vₜ conditioned on \hat{X}ₜ₋₁ and \tilde{p}ⱼ. This is difficult because the intermediate variable pᵢ, is a heavily non-linear function of X In order to compute pᵢ(X) the world coordinates W(X) are determined, which includes the absolute orientation of each body part. Then pi is transformed from its location in the mesh to its final location in the world.

To tackle this problem, observe that Xₜ is a deterministic function of Vₜ and \hat{X}ₜ₋₁. Therefore, pi can be directly defined as a non-linear function, denoted Pᵢ of Vₜ and the fixed \hat{X}ₜ₋₁ and \hat{V}ₜ₋₁. Then \tilde{p}ⱼ is a non-linear function of Vₜ, corrupted with additive Gaussian noise. The distribution P(Vₜ|\hat{V}ₜ₋₁) is a Gaussian as well. One basic approach is to linearize the function Pᵢ. This results in a simple linear Gaussian network approximation. Performing MAP inference on this model is easy, so we can determine an estimate of argmax P(Vₜ|\hat{X}ₜ₋₁, \hat{V}ₜ₋₁, \tilde{p}ⱼ). The function can then be relinearized about this new estimate, and the procedure iterated until convergence. It will be understood that there are many ways to linearize the non-linear function. In one implementation an unscented transform, which is used in the unscented Kalman filter in a similar situation, is applied. The basic approach is to compute sigma points from the prior distribution on Vₜ, apply the non-linear function to them, and then approximate the result with a Gaussian distribution, in which evidence can easily be integrated. This method provides an estimate of the distribution that is generally more accurate than linearization through calculating an analytic Jacobian.

Accordingly, given a known correspondence between a point in the image and a point in the mesh, approximate MAP inference can be performed using the described algorithms. These algorithms involve inverse kinematics methods, such as those using non-linear least squares, with linearization performed using the unscented transform, and it allows prior distributions on the variables.

An algorithm is employed for determining \hat{X}ₜ from \hat{X}ₜ₋₁ and zₜ. For the following explanation of such aspects, it can be assumed that there exists a set of part detections and their estimated body part classes, {\tilde{p}ⱼ,\tilde{c}ⱼ}. The algorithm begins with an initial guess X^{best}ₜ, set to \hat{X}ₜ₋₁, which is repeatedly improved by integrating part detections.

The algorithm begins by updating X^{best} with the estimate from running hill-climbing as described herein. Part detections are then extracted from the measurement zₜ. This results in there being a large number of possible combinations. For instance, deciding, for each detected part, whether it is spurious, and if not, which specific body part it is associated, represents a large number of potential decisions. Considering each such combination, e.g., by performing hill-climbing, can be prohibitively time consuming, especially for a real-time system. Therefore, aspects of the present disclosure recognize that all detections near any detectable part can be removed without considering the estimated body part classes. This effectively culls the part detections to those that propose moving a body part to a position in the image where no part currently exists. The next step is to expand the detections into a set of concrete correspondences. A candidate correspondence {(pᵢ,\tilde{p}ᵢ)} is created for each body part to all detections with a matching class, that is cᵢ=\tilde{c}ⱼ. For instance, a correspondence is created for the right hand to all hand detections.

At this point, a concrete list of possible correspondences has been generated from which a subset is to be chosen. In one implementation, this problem can be approached in a greedy fashion by iterating through each possible correspondence, and apply evidence propagation (EP), initialized from X^{best} to find a new posterior mode X′ which incorporates the current correspondence only. EP thus allows for a big jump in the state space. Then local hill-climbing is restarted from X′ to refine it. If the final likelihood is better than X^{best}, X^{best} is replaced with the pose found. When this occurs, the candidate correspondence is considered to be accepted. The only effect of this on the subsequent iterations of the algorithm is through its update of X^{best}. The correspondence is not incorporated during subsequent states of EP, so that subsequent, possibly better, correspondences can override earlier ones.

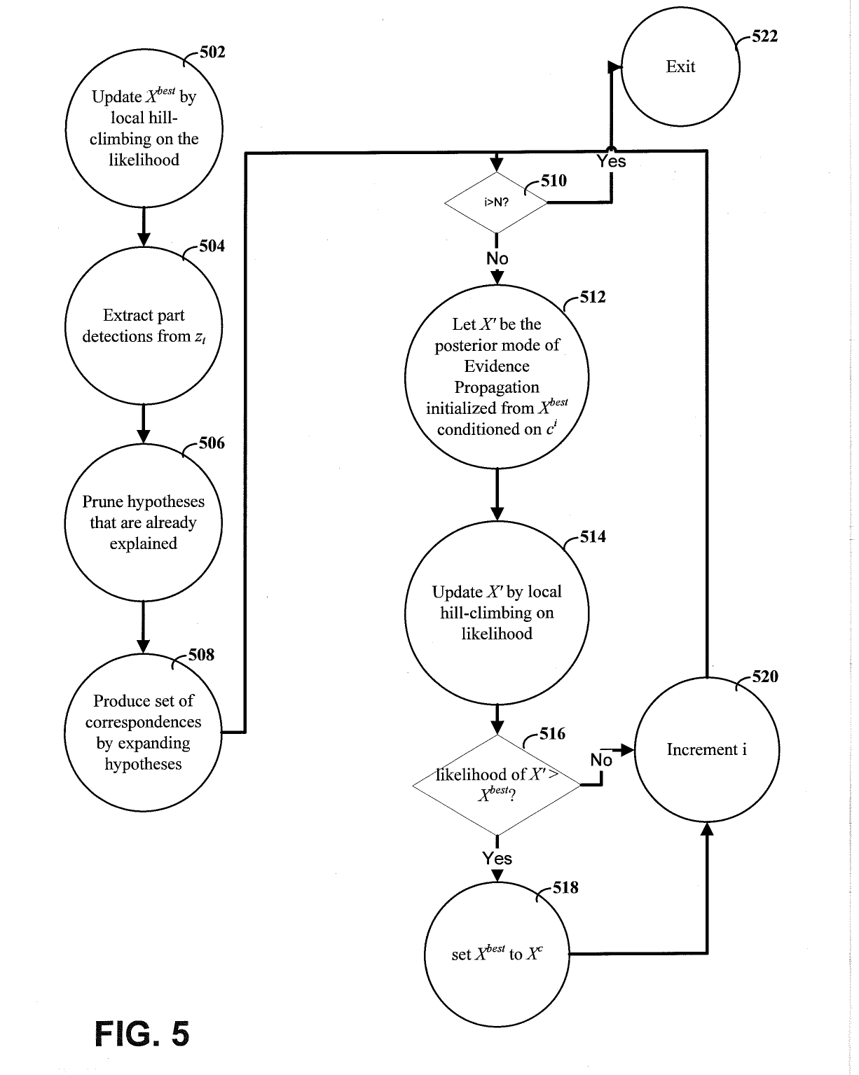

FIG. 5 depicts a flow diagram consistent with the above description and consistent with aspects of the present disclosure. At step 502, X^{best} is updated by local hill-climbing on the likelihood. At step 504, part detections are extracted from zₜ. At step 506, hypotheses that are already explained are pruned. At step 508, a set of correspondences {(pᵢ,\tilde{p}ⱼ)} is produced by expanding hypotheses. Steps 510-520 represent set of action that are incrementally implemented for i=1 to N. Step 510 determines whether or not i is greater than N and in response determine whether or not to exit (522). At step 512, X′ is set to the posterior mode of Evidence Propagation initialized from X^{best} conditioned on cⁱ. At step 514, X′ is updated using local hill-climbing on likelihood. A decision is made at step 516 as to whether the likelihood of X′>X^{best}. If so, step 518 sets X^{best} to X^{c}. Step 520 involves incrementing i, after which the flow returns to step 510.

Consistent with FIG. 5, this algorithm performs local hill climbing so long as the discriminative model does not find any unexplained evidence. During frames with unexplained evidence, the algorithm will perform more searches with bigger jumps, allowing it to again find the correct state and recover.

FIG. 6 depicts results obtained from experimental implementations of a tracking algorithm, consistent with aspects of the present disclosure. The figure shows results of three exemplary frames (e.g., 11837, 11843 and 11854) from a sequence of movements corresponding to an image sequence of a tennis player. The model-based search (top row) loses track of the tennis swing, which is believed to be caused by occlusion of the arm. The combined tracker described herein integrates bottom-up evidence about body parts (bottom row) and is able to recapture the fast moving arm even after an occlusion and catch trailing edge of the Tennis serve. The figure also illustrates through straight lines from the detected part the associations that the algorithm considered, and how this enables it to use EP to pull itself back on track.

Aspects of the present disclosure recognize that smoothing can affect the likelihood and the performance of algorithms. Experimental results lead to the discovery that the smooth likelihood improved the performance in terms of average error across all sequences and frames by about 10 percent for the model based algorithm and 18 percent for the combined algorithm. The fact that it helped the combined approach more may be a result of the fact that the reinitialization is not always close enough to regain track with the non-smooth likelihood function.

The various embodiments as discussed herein may be implemented using a variety of structures and related operations and functions. For instance, while many of the descriptions herein may involve software or firmware that plays a role in implementing various functions, various embodiments are directed to implementations in which the hardware includes all necessary resources for such adaptation, without necessarily requiring any involvement of software and/or firmware. Also, various descriptions herein can include hardware having a number of interacting state machines. Moreover, aspects of these and other embodiments may include implementations in which the hardware is organized into a different set and/or number of state machines, including a single state machine, as well as random-logic implementations that may not be clearly mapped to any number of finite-state machines. While various embodiments can be realized via hardware description language that is computer-synthesized to a library of standard modules, aspects of the invention should also be understood to cover other implementations including, but not limited to, field-programmable or masked gate arrays, seas of gates, optical circuits, board designs composed of standard circuits, microcode implementations, and software- and firmware-dominated implementations in which most or all of the functions described as being implemented by hardware herein are instead accomplished by software or firmware running on a general- or special-purpose processor. These embodiments may also be used in combination, for example certain functions can be implemented using programmable logic that generates an output that is provided as an input to a processor.

Aspects of the present disclosure relate to capture of lifelike motion data, and real time representations thereof. It will be understood by those skilled in the relevant art that the above-described implementations are merely exemplary, and many changes can be made without departing from the true spirit and scope of the present disclosure. Therefore, it is intended by the appended claims to cover all such changes and modifications that come within the true spirit and scope of this invention.

What is claimed is:

1. A system for tracking at least one object articulated in three-dimensional space using data obtained from a depth sensor, the system comprising:
at least one processing circuit configured and arranged to:
determine location probabilities for a plurality of object parts by identifying, from image data obtained from the depth sensor, features of the object parts;
select a set of poses for the at least one object based upon the determined location probabilities;
generate modeled depth sensor data by applying the selected set of poses to a model of the at least one object; and
select a pose for the at least one object model-based based upon a probabilistic comparison between the data obtained from the depth sensor and the modeled depth sensor data.

2. The system of claim 1, wherein the at least one processing circuit is further configured and arranged to determine location probabilities using a learning-based system that predicts the poses of object parts for an entire depth image.

3. The system of claim 1, wherein the at least one processing circuit is further configured and arranged to learn a part classifier by generating modeled sensor data and learn parts from the modeled sensor data, and wherein the determining location probabilities by identifying features includes using a geometry-based identification system to analyze connectivity structure of the data obtained from the depth sensor and using the learned part classifier to identify the object parts.

4. The system of claim 1, wherein the at least one processing circuit is further configured and arranged to the propagation of belief in a graphical model that represents the object as a kinematic chain.

5. The system of claim 1, wherein the at least one processing circuit is further configured and arranged to use an unscented transform to filter the data obtained from a depth sensor.

6. The system of claim 1, wherein the at least one processing circuit is further configured and arranged to select a probable pose using a per-pixel cost function.

7. The system of claim 1, wherein the at least one processing circuit is further configured and arranged to select a probable pose using of a three-dimensional smoothing cost function that determines a local minimal cost at each object pixel.

8. The system of claim 1, wherein the at least one processing circuit includes a graphics processing unit further configured and arranged to directly perform cost evaluation for a hypothesis.

9. The system of claim 8, wherein the cost evaluation includes a comparison between corresponding pixel depths for the hypothesis and a data obtained from a sensor.

10. A circuit-implemented method for tracking at least one object articulated in three-dimensional space using data obtained from a depth sensor, the method comprising:
determining location probabilities for a plurality of object parts by identifying, from image data obtained from the depth sensor, features of the object parts;
selecting a set of poses for the at least one object based upon the determined location probabilities;
generating modeled depth sensor data by applying the selected set of poses to a model of the at least one object; and
selecting a pose for the at least one object model-based based upon a probabilistic comparison between the data obtained from the depth sensor and the modeled depth sensor data.

11. The method of claim 10, wherein the step of determining location probabilities includes a learning-based system that predicts the poses of object parts for an entire depth image.

12. The method of claim 10, further including the step of learning a part classifier by generating modeled sensor data and learning parts from the modeled sensor data, and wherein the step of determining location probabilities by identifying features includes using a geometry-based identification system to analyze connectivity structure of the data obtained from the depth sensor and using the learned part classifier to identify the object parts.

13. The method of claim 10, further including the step of using the propagation of belief in a graphical model that represents the object as a kinematic chain.

14. The method of claim 10, further including the use of an unscented transform to filter the data obtained from a depth sensor.

15. The method of claim 10, wherein the step of selecting a probable pose includes using a per-pixel cost function.

16. The method of claim 10, wherein the step of selecting a probable pose includes the use of a three-dimensional smoothing cost function that determines a local minimal cost at each object pixel.

17. The method of claim 10, wherein cost evaluation for a hypothesis is performed directly on a graphics processing unit.

18. The method of claim 10, wherein the step of identifying features of the object parts from image data obtained from the depth sensor detector includes learning the features on a per-frame basis.

19. The method of claim 10, wherein the step of identifying features of the object parts from image data obtained from the depth sensor detector includes learning the features as part of an offline and separate training phase.

20. The method of claim 10, where the step of identifying features of the object parts from image data obtained from the depth sensor detector includes finding, from local image structures, receptor features and using the receptor features to identify the object parts from the image data.
